(19) United States
(12) Patent Application Publication
(10) Pub. No.: US 2007/0190959 A1
(43) Pub. Date: Aug. 16, 2007

(54) Apparatus and method for frequency conversion with minimized intermodulation distortion

(76) Inventors: Woonyun Kim, Yongin-Si (KR); Hyun-Seok Kim, Gwacheon-si (KR)

Correspondence Address: LAW OFFICE OF MONICA H CHOI, P O BOX 3424, DUBLIN, OH, 430160204, US

(21) Appl. No.: 11/705,237

(22) Filed: Feb. 12, 2007

(30) Foreign Application Priority Data
Feb. 14, 2006 (KR) 2006-14118

(51) Int. Cl. H04B 1/26; H04B 15/00

(52) U.S. Cl. 455/313

(57) ABSTRACT

A frequency conversion unit includes a local oscillator, a phase compensator, and a mixer. The local oscillator generates differential original oscillating signals. The phase compensator generates differential compensated oscillating signals mixed with differential received signals by the mixer to generate differential baseband signals. The respective duty cycles of the compensated oscillating signals are adjusted for minimizing intermodulation distortion in the baseband signals.

This application claims priority under 35 USC § 119 to Korean Patent Application No. 2006-14118, filed on Feb. 14, 2006 in the Korean Intellectual Property Office, the disclosure of which is incorporated herein in its entirety by reference.

### BACKGROUND OF THE INVENTION

1. Field of the Invention

The present invention relates generally to wireless communication, and more particularly to frequency conversion with duty cycle adjustment of oscillating signals to reduce intermodulation distortion in a direct-conversion receiver.

2. Background of the Invention

Frequency conversion according to a zero intermediate frequency (zero-IF) technique includes a direct-conversion technique. In contrast, frequency conversion according to a superheterodyne technique includes a dual-conversion technique. The zero-IF technique directly converts a carrier signal to and from a baseband signal without any IF stages.

Because of disadvantages of the zero-IF technique, the superheterodyne technique is widely employed for excellent channel selectivity characteristics. On the other hand, the zero-IF system may reduce the need for a surface acoustic wave (SAW) filter, a mixer and so on. Thus, the zero-IF system may reduce cost and weight, and the zero-IF system may be implemented on one chip.

There have been various attempts to use the zero-IF technique in mobile communication, such as in the Global System for Mobile Communications (GSM). Thereafter, mobile communication systems employing the zero-IF technique have become widespread. In particular, a direct-conversion receiver (DCR) adopting the zero-IF technique has a simple circuit structure, low manufacturing cost, and smaller size compared with a superheterodyne receiver.

However, the DCR exhibits second-order intermodulation distortion (IMD2) in a frequency mixer of the DCR. The IMD2 results from non-linearity of such a frequency mixer having non-linear active elements. When an input signal eᵢ is applied to a non-linear system, an output signal eₒ is generated as represented by the following Expression 1, where α₁, α₂, and α₃ represent first, second and third order harmonic coefficients, respectively.

e₀=α₀+α₁ e₁+α₂ eᵢ²+α₃ eᵢ³+ [Expression 1]

The output signal e₀ may be represented as a sum of harmonic waves. Various frequency signals are mixed with one another, and then new frequency signals are generated according to Expression 1 in the non-linear system.

When the input signal eᵢ including two frequency components f1 and f2, or an input signal eᵢ having two tones, is applied to a generic non-linear circuit, other frequency components, such as 2*f1, 2*f2, f1−f2, f1+f2, 3*f1, 3*f2, 2*f1−f2, 2*f2−f1, 2*f1+f2, 2*f2+f1 and so on, as well as the input frequency components f1 and f2, are generated due to the non-linearity of the non-linear circuit.

Typically, the other frequency components generated due to the non-linearity may be removed by a filter. However, when the input frequency components f1 and f2 are similar or identical with each other, and when a target frequency signal is for the baseband frequency, the frequency components f1−f2 close to the baseband frequency are hardly removed by the filter. These frequency component signals interfere with one another between channels having a small frequency difference, or distortion effects occur as signals within a particular frequency band interfere with one another.

The frequency component, resulting from a second-order component (or a second-power term) such as the f1−f2 component or the f1+f2 component, is referred to as the IMD2 component. In a system such as the DCR, the f1−f2 component may be included in a pass band filter for filtering a target frequency signal. In that case, the f1−f2 component is not removed by the filter.

A relationship between a level of the IMD2 and an amplified level of an input frequency may represent a linearity of a circuit of the DCR system. The degree of the linearity of the circuit of the DCR system is represented by a second-order intercept point (IP2).

When the input frequency signal increases, a power of the IMD2 signal increases faster than a power of a target output frequency signal. Initially, the power level of the initial IMD2 signal is less than the power level of the output frequency signal. However, ultimately, the power level of the IMD2 signal becomes equal to the power level of the target output frequency signal. The power point where the power level of the IMD2 signal is identical with the power level of the target output frequency signal is referred to as the IP2. An input IP2 (IIP2) represents an IP2 in view of an input, and an output IP2 (OIP2) represents an IP2 in view of an output.

The larger the IP2, the higher the linearity, because a high power level of the input frequency signal is required in order to obtain the sufficient power level of the target output frequency signal. Since the DCR shifts the target frequency signal directly to the baseband, the IMD2 signal that is generated by the frequency mixer and is located in the baseband may degrade the performance of the DCR. Therefore, a frequency-mixing device or a frequency mixer having a high IP2 value (or a low IMD2) is desired for the DCR.

FIG. 1 is a circuit diagram of a conventional Gilbert cell mixer. Referring to FIG. 1, the Gilbert cell mixer, a kind of balanced active mixer typically having a differential output characteristic, includes an emitter-coupled transistor pair Q1 and Q2 for inputting a radio frequency (RF) signal pair RF+ and RF−, degeneration resistors RE1 and RE2, Gilbert cell core transistors Q3, Q4, Q5 and Q6, pull-up resistors R1 and R2, and differential output nodes NO1 and NO2.

When an identical second-order harmonic component is generated at each of the differential output nodes NO1 and NO2, the second-order harmonic components of both differential output nodes NO1 and NO2 are counterbalanced with each other by a common-mode removal characteristic. As a result, the second-order harmonic components may be removed.

However, the second-order harmonic components are not completely removed since the second-order harmonic components are generated at the differential output nodes NO1 and NO2 with mismatches in phases and amplitudes of the second-order harmonic components. Such phase and amplitude mismatches may be caused by a mismatch between the emitter-coupled transistor pair Q1 and Q2, a mismatch between the degeneration resistors RE1 and RE2, a duty ratio characteristic of a local oscillator LO, a mismatch between the pull-up resistors R1 and R2, and a mismatch between input RF signals RF+ and RF−. Unfortunately, such differential characteristics are difficult to match perfectly for eliminating the second-order harmonic components.

Generally, a DCR includes an IP2 calibration circuit for controlling the IP2. FIG. 2 is a circuit diagram illustrating a conventional IP2 calibration circuit. Referring to FIG. 2, the IP2 calibration circuit includes a mixer 200 and an IP2 modulator 202.

The mixer 200 includes a first pair of input terminals 204 for receiving a carrier signal V_{RF} and a second pair of input terminals 206 for receiving a local oscillation signal V_{LO}. The mixer 200 outputs a signal having a frequency that is the difference between the frequency of the carrier signal V_{RF} and the frequency of the local oscillation signal V_{LO}. The output signal of the mixer 200 is generated at a pair of output terminals 208.

The IP2 modulator 202 includes load resistors R_{LP}, R_{LN}, and a calibrating resistor R_{CAL}. The calibrating resistor R_{CAL} is connected in parallel to the load resistor R_{LP}. The calibrating resistor R_{CAL} compensates for a mismatch between differential outputs BB+ and BB− of the mixer 200. A total second-order intermodulation (IM2) output voltage is obtained by summing the IM2 output voltage in a common mode and the IM2 output voltage in a differential mode.

The IM2 output voltage V_{IM2,CM} in the common mode is given by the following Expression 2.

V_{IM2,CM}=i_{CM}(R+ΔR−R_{C})−i_{CM}(R−ΔR)=i_{CM}(2ΔR−R_{C}) [Expression 2]

R_{LN} is represented by R−ΔR, R_{C} denotes a decrease in the resistance value of R_{LP} (e.g. R_{LP}=R+ΔR) due to R_{CAL}, and i_{CM} represents a current in a common mode.

The IM2 output voltage V_{IM2,DM} in the differential mode is given by the following Expression 3.

V_{IM2,DM}=i_{DM}(R+ΔR−R_{C})+i_{DM}(R−ΔR)=i_{DM}(2R−R_{C}) [Expression 3]

R_{LN} is represented by R−ΔR, R_{C} denotes a decrease in the resistance value of R_{LP} (e.g. R_{LP}=R+ΔR) due to R_{CAL}, and i_{DM} represents a current in a differential mode. Therefore, the total IM2 output voltage V_{IM2} is given by the following Expression 4.

V_{IM2}=V_{IM2,CM}+V_{IM2,DM}=i_{CM}(2R−R_{C})+i_{DM}(2ΔR−R_{C}) [Expression 4]

### In this manner, the IP2 can be calibrated by adjusting R_{C} to reduce V_{IM2}.

Typically, the IIP2 of a doubled balanced mixer is given by the following Expression 5.

$$IIP 2 = \frac{\frac{4 \sqrt{2}}{π}}{{η}_{norm} {α}_{2}^{′} [ \begin{matrix}Δ η ( Δ {g}_{m} + Δ {A}_{RF} ) + \\ Δ R ( 1 + Δ {g}_{m} ) ( 1 + Δ {A}_{RF} )\end{matrix} ]} \qquad [ Expression 5 ]$$

α′₂ represents a second-order harmonic coefficient, ΔA_{RF} represents a mismatch between input RF signals RF+ and RF−, Δη represents a mismatch of a duty cycle between local oscillation signals VLO+ and VLO−, Δgₘ represents a mismatch of transconductances between a pair of transistors Q1 and Q2, ΔR is a mismatch of a pull-up resistors R1 and R2, and ηₙₒᵣₘ corresponds to 0.5.

FIG. 8 is a graph illustrating IP2 values versus Δη when ΔR varies in Expression 5. In FIG. 8, curves A, B, C, and D represent cases where ΔR is 0%, 0.01%, 0.1% and 0.5%, respectively. Referring to FIG. 8, the IP2 values vary significantly with small ΔR variation. That is, the doubled balanced mixer is significantly sensitive to the variation of ΔR.

In addition, calibration using the resistor R_{CAL} has a limit in a semiconductor manufacturing process. When ΔR is in a range of from about 0.1% to 10% of R, R_{C} is also in a range of from about 0.1% to 10% of R. Therefore, the resistor R_{CAL} is about 10 to 1,000 times as large as the resistance of R. Thus, when R is tens of KΩ (kilo-ohms), R_{CAL} is tens of MΩ (mega-ohms). Such a large resistance for R_{CAL} which would occupy a large area or require additional logic circuit is difficult to realize in a semiconductor manufacturing process.

### SUMMARY OF THE INVENTION

Accordingly, duty cycles of the oscillating signals are adjusted for reducing intermodulation distortion in frequency conversion.

A frequency conversion unit includes a local oscillator, a phase compensator, and a mixer. The local oscillator generates differential original oscillating signals. The phase compensator generates differential compensated oscillating signals from the original oscillating signals with a respective duty cycle of each of the compensated oscillating signals being adjusted by the phase compensator. The mixer mixes the compensated oscillating signals with differential received signals to generate differential baseband signals. The respective duty cycle of each of the compensated oscillating signals is adjusted by the phase compensator for minimizing intermodulation distortion in the baseband signals.

In an example embodiment of the present invention, the phase compensator includes first and second differential amplifiers. The first differential amplifier, biased with a first current, includes first inputs with the original oscillating signals applied thereon, and includes first outputs coupled to differential output terminals having the compensated oscillating signals generated thereon. The second differential amplifier, biased with a second current, includes second inputs with the original oscillating signals applied thereon, and includes second outputs coupled to the differential pair of output terminals. The first and second currents are adjusted for setting the respective duty cycle of each of the compensated oscillating signals.

In another embodiment of the present invention, a sum of the first and second currents is maintained to be constant.

In a further embodiment of the present invention, the phase compensator further includes first and second BJTs (bipolar junction transistors) and a current source. The first BJT generates the first current and has a first base with a first base voltage applied thereon for setting the first current. The second BJT generates the second current and has a second base with a second base voltage applied thereon for setting the second current. The current source is coupled to the first and second BJTs and generates a fixed current such that a sum of the first and second currents is the fixed current.

The first differential amplifier, biased with the first current, includes a first pair of transistors with the original oscillating signals applied thereon. The second differential amplifier, biased with the second current, includes a second pair of transistors with the original oscillating signals applied thereon. A first size ratio between the first pair of transistors and a second size ratio between the second pair of transistors are set for determining the respective duty cycle of each of the compensated oscillating signals.

The frequency conversion unit may be used to particular advantage in a direct-conversion receiver (DCR). Such a DCR also includes a receiving unit for receiving differential RF signals that is mixed with the compensated oscillating signals in the mixer to generate the differential baseband signals. The DCR also includes a baseband signal processor for receiving and processing the baseband signals.

In another example embodiment of the present invention, the DCR further includes a phase compensator controller that generates at least one control signal from the baseband signals to minimize intermodulation distortion in the baseband signals. The phase compensator adjusts the respective duty cycle of each of the compensated oscillating signals in response to the at least one control signal.

### BRIEF DESCRIPTION OF THE DRAWINGS

The above and other features and advantages of the present invention will become more apparent when described in detailed exemplary embodiments thereof with reference to the attached drawings in which:

FIG. 1 is a circuit diagram of a conventional Gilbert cell mixer;

FIG. 2 is a circuit diagram of a conventional IP2 calibration circuit using a calibration resistor;

FIG. 3 is a block diagram of a DCR (direct-conversion receiver) according to an embodiment of the present invention;

FIG. 4 is a circuit diagram of a phase compensator in FIG. 3, according to embodiment of the present invention;

FIG. 5 is a circuit diagram of the phase compensator in FIG. 3, according to another embodiment of the present invention;

FIG. 6 shows a waveform diagram of example output signals of the phase compensator of FIG. 4;

FIGS. 7A, 7B, 7C, and 7D show waveform diagrams of input and output signals of the phase compensator of FIG. 4, according to another embodiment of the present invention;

FIG. 8 is a graph of IP2 values versus Δη when ΔR varies in Expression 5;

FIG. 9 is a graph of IP2 values versus ΔR when Δη varies in Expression 5; and

FIG. 10 shows a flow chart of steps during operation of the DCR of FIG. 3, according to an embodiment of the present invention.

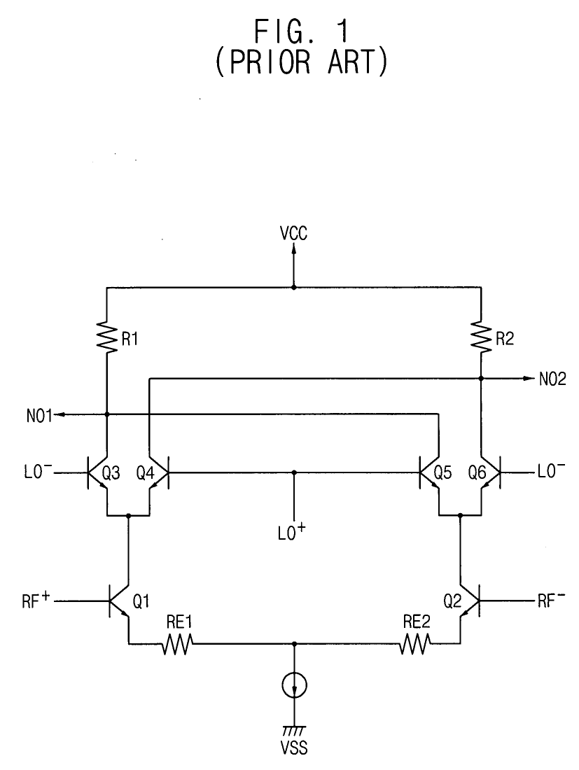

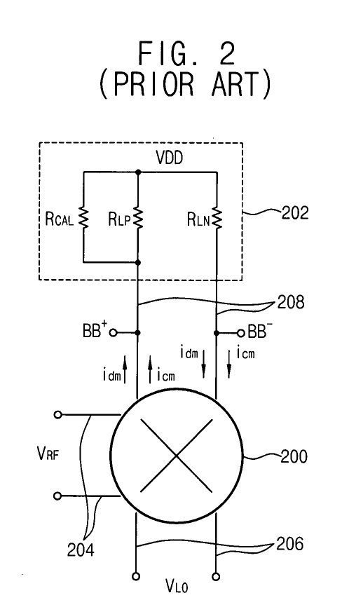

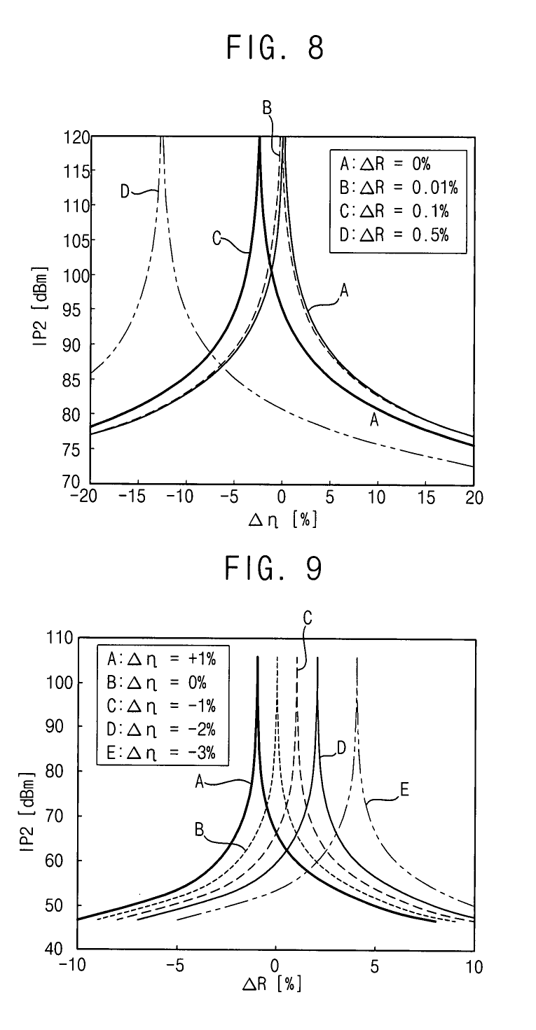

The figures referred to herein are drawn for clarity of illustration and are not necessarily drawn to scale. Elements having the same reference number in FIGS. 1, 2, 3, 4, 5, 6, 7A, 7B, 7C, 7D, 8, 9, and 10 refer to elements having similar structure and/or function.

### DETAILED DESCRIPTION OF THE INVENTION

Embodiments of the present invention are now described more fully with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

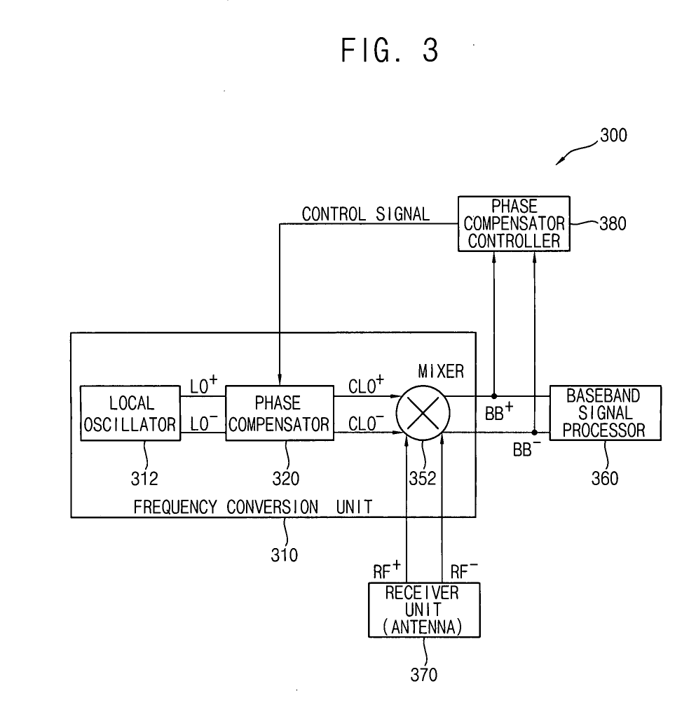

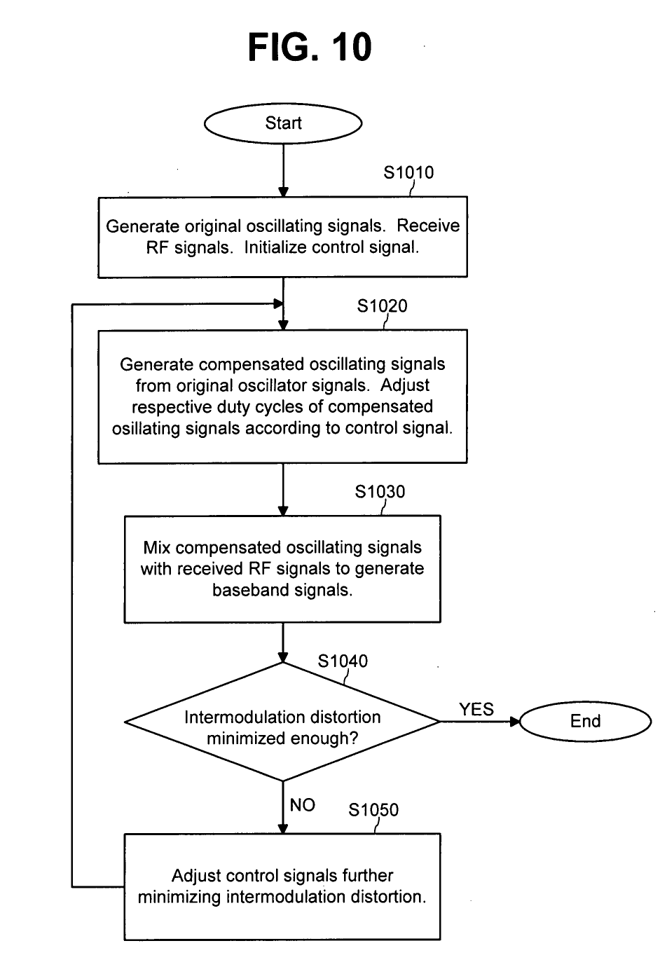

FIG. 3 shows a block diagram of a DCR (direct-conversion receiver) 300 according to an example embodiment of the present invention. Referring to FIG. 3, the DCR 300 includes a frequency conversion unit 310, a receiver unit 370, a phase compensator controller 380, and a baseband signal processor 360. The frequency conversion unit 310 includes a local oscillator 312, a phase compensator 320, and a mixer 352. FIG. 10 shows a flowchart of steps during operation of the DCR 300 of FIG. 3, according to an example embodiment of the present invention.

The receiver unit 370 may for example be an antenna for receiving differential radio frequency (RF) signals RF+ and RF− (step S1010 of FIG. 10). The local oscillator 312 generates a differential pair of original oscillating signals LO+ and LO− that have substantially the same frequency as a frequency of a carrier wave of the received RF signals (step S1010 of FIG. 10). For example, the local oscillator 312 may be implemented with a voltage-controlled oscillator (VCO).

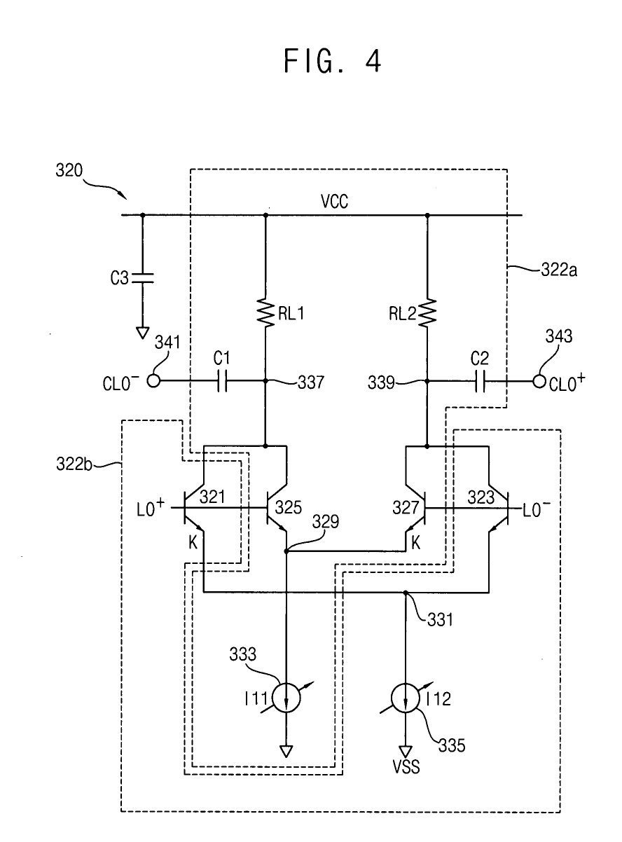

The phase compensator 320 amplifies a difference of the differential oscillating signals LO+ and LO− applied at input terminals and generates a differential pair of compensated oscillating signals CLO+ and CLO− (step S1020 of FIG. 10) at output terminals (341 and 343 in FIG. 4 for example). The phase compensator 320 adjusts a respective duty cycle of each of the compensated oscillating signals CLO+ and CLO− in accordance with at least one control signal from the phase compensator controller 380 (step S1020 of FIG. 10).

The mixer 352 mixes the compensated oscillating signals CLO+ and CLO− with the received RF signals to generate differential baseband signals BB+ and BB− (step S1030 of FIG. 10). In an example embodiment of the present invention, the phase compensator controller 380 generates the control signal to the phase compensator 320 from the differential baseband signals BB+ and BB−.

For example, the phase compensator controller 380 analyzes the baseband signals BB+ and BB− to determine the level of the second order intermodulation distortion (IMD2) in the baseband signals BB+ and BB− and generates the control signal to the phase compensator 320 for minimizing such intermodulation distortion in the baseband signals BB+ and BB− (steps S1040 and S1050 of FIG. 10). The control signal to the phase compensator 320 determines the respective duty cycle of each of the compensated oscillating signals CLO+ and CLO− generated by the phase compensator 320.

The control signal to the phase compensator 320 is initialized (step S1010 in FIG. 10). Thereafter, the phase compensator controller 380 adjusts the control signal (steps S1040 and S1050 of FIG. 10) until the level of the second order intermodulation distortion (IMD2) in the baseband signals BB+ and BB− is minimized to a satisfactory extent. The baseband signal processor 360 receives the baseband signals BB+ and BB− for further processing.

However, the present invention may also be practiced without the phase compensator controller 380. In that case, the second order intermodulation distortion (IMD2) in the baseband signals BB+ and BB− may be analyzed by a user, and the at least one control signal to the phase compensator 320 for minimizing the intermodulation distortion may be provided externally.

FIG. 4 shows a circuit diagram of the phase compensator 320 in FIG. 3 according to an example embodiment of the present invention. Referring to FIGS. 3 and 4, the phase compensator 320 includes a first differential amplifier 322a and a second differential amplifier 322b.

The first differential amplifier 322a includes common load resistors RL1 and RL2, a first pair of transistors 325 and 327, and a first current source 333. The common load resistors RL1 and RL2 are coupled to a power supply voltage VCC and corresponding nodes 337 and 339. The transistors 325 and 327 are BJTs (bipolar junction transistors) connected as a first differential amplifier for amplifying a difference between the oscillating signals LO+ and LO− applied on the corresponding bases of the BJTs 325 and 327.

The collectors of the BJTs 325 and 327 are coupled to the corresponding nodes 337 and 339. Respective coupling capacitors C1 and C2 are connected between the corresponding nodes 337 and 339 and corresponding output terminals 341 and 343.

In an example embodiment of the present invention, a first size ratio between the BJTs 325 and 327 is 1:K, where K is a natural number. Thus, the BJT 327 conducts K times more current than the BJT 325. The first current source 333 sinks a first current I11 from a node 329 connected to the emitters of the BJTs 325 and 327 to a ground voltage node VSS. Thus, the sum of the currents through the BJTs 325 and 327 is the first current I11.

The second differential amplifier 322b is implemented with the common load resistors RL1 and RL2, a second pair of transistors 321 and 323, and a second current source 335. The transistors 321 and 323 are BJTs (bipolar junction transistors) connected as a second differential amplifier for amplifying a difference between the oscillating signals LO+ and LO− applied on the corresponding bases of the BJTs 321 and 323.

The collectors of the BJTs 321 and 323 are coupled to the corresponding nodes 337 and 339. A second size ratio between the BJT transistor 323 and the BJT transistor 321 is 1:K. Thus, the BJT 321 conducts K times more current than the BJT 323. The second current source 335 sinks a second current I12 from a node 331 connected to the emitters of the BJTs 321 and 323 to the ground voltage node VSS. Thus, the sum of the currents through the BJTs 321 and 323 is the second current I12.

With such a configuration of FIG. 4, the respective duty cycle of each of the compensated oscillating signals CLO+ and CLO− generated at the output terminals 343 and 341, respectively, is adjusted according to level of the first current I11 and the level of the second current I12. Furthermore, in an example embodiment of the present invention, a sum of the first current I11 and the second current I12 is maintained to be constant. The first current I11 generated by the first current source 333 and the second current I12 generated by the second current source 335 are controlled by the at least one control signal from the phase compensator controller 380.

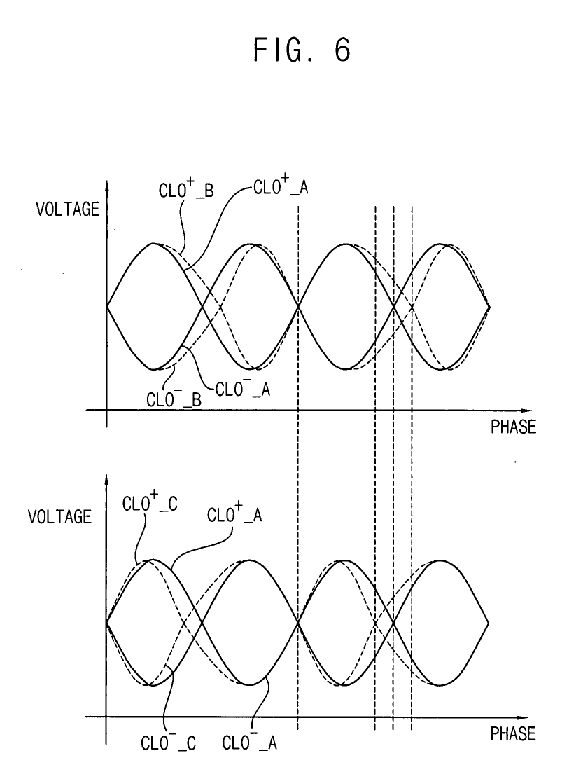

FIG. 6 shows waveform diagrams of example output signals from the phase compensator 320 of FIG. 4. Referring to FIGS. 4 and 6, by adjusting the first current I11 and/or the second current I12, the phase compensator 320 may generate the various example output signals CLO+_A and CLO−_A, CLO+_B and CLO−_B, or CLO+_C and CLO−_C, having different duty cycles.

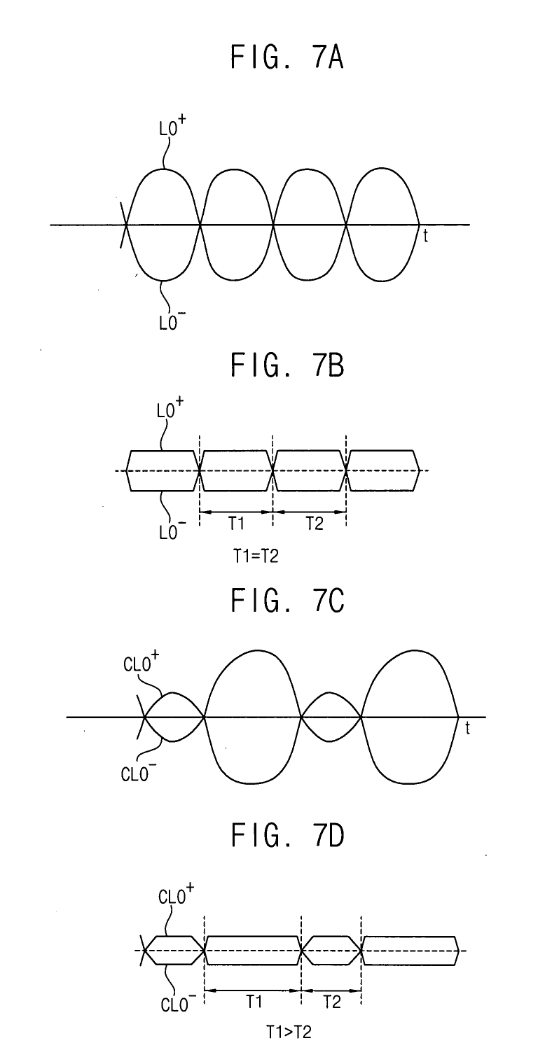

FIGS. 7A, 7B, 7C, and 7D show waveform diagrams of input and output signals of the phase compensator 320 of FIG. 4. Referring to FIGS. 4 and 7A through 7D, a method of controlling a duty cycle of the differential pair of output signals CLO+ and CLO− outputted from the phase compensator 320 may be described as follows.

Because of the first and second size ratios of 1:K between the BJTs 325 and 327 and 323 and 321, with operation of one of the first and second differential amplifiers 322a and 322b, a differential DC offset voltage is generated between the compensated oscillating signals CLO+ and CLO−.

FIG. 7A is a waveform diagram of the original oscillating signals LO+ and LO− input to the phase compensator 320. FIG. 7C is a waveform diagram of the compensated oscillating signals CLO+ and CLO− output from the phase compensator 320 with the differential DC offset voltage. When the magnitude of the compensated oscillating signals CLO+ and CLO− is sufficiently large, such signals CLO+ and CLO− are saturated. FIG. 7B is a waveform diagram of the saturated original oscillating signals LO+ and LO− of FIG. 7A, and FIG. 7D is a waveform diagram of the saturated compensated oscillating signals CLO+ and CLO− of FIG. 7C.

Referring to FIG. 7B, an interval of T1 (a period during which a first differential original oscillating signal LO+ is at the logic low state) is substantially identical with an interval of T2 (a period during which a second differential original oscillating signal LO− is at the logic low state). However, referring to FIG. 7D, an interval of T1 (a period during which a first compensated oscillating signal CLO+ is at the logic low state) is longer than an interval of T2 (a period during which a second compensated oscillating signal CLO− is at the logic low state). As illustrated, the respective duty cycle of each of the compensated oscillating signals CLO+ and CLO− is set by the phase compensator 320.

By adjustment of the first and second currents levels I11 and I12 and/or the size ratio 1:K, the intervals T1 and T2 are set for determining the respective duty cycle of each of the compensated oscillating signals CLO+ and CLO−. For example, when a sum of the first current I11 of the first current source 333 and the second current I12 of the second current source 335 is maintained at a fixed value, an increase of the first current I11 by ΔI causes a decrease of the second current I12 by ΔI.

The first differential compensated output signal CLO+ is represented by the following Expression 6:

CLO⁺=R_{L}(l₁ tan h(LO⁺N_{T}+V_{K})+I₂ tan h(LO⁺N_{T}−V_{K})) [Expression 6]

V_{K}=ln(K)

R_{L} represents a load resistance of the load resistor RL2. V_{T} represents a threshold voltage of each of the transistors 321, 323, 325 and 327. K represents the size ratio between transistors 323 and 321 (and/or between transistors 325 and 327). Therefore, the respective duty cycle of each of the compensated oscillating signals CLO+ and CLO− is determined by at least one of K, the first current I11, and the second current I12.

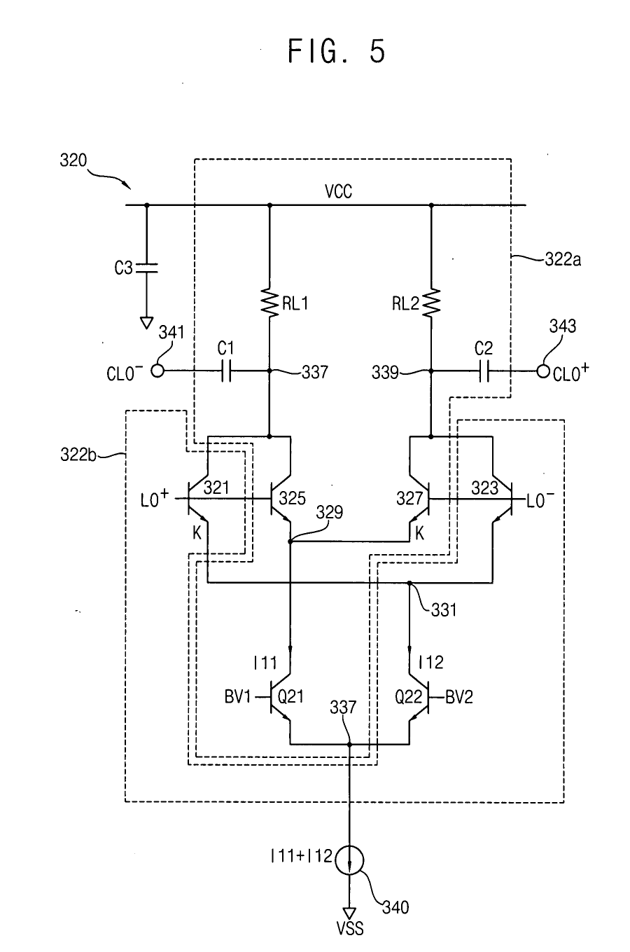

FIG. 5 is a circuit diagram of the phase compensator 320 of FIG. 3, according to another embodiment of the present invention. Elements having the same reference number in FIGS. 4 and 5 refer to elements having similar structure and/or function.

However, the first and second current sources 333 and 335 of FIG. 4 are replaced with bipolar junction transistors (BJTs) Q21 and Q22 and a current source 340. The BJTs Q21 and Q22 generate the first and second currents I11 and I12, respectively, in response to bias voltages BV1 and BV2, respectively. Such bias voltages BV1 and BV2 are applied on the bases of the BJTs Q21 and Q22, respectively.

In an example embodiment of the present invention, such bias voltages BV1 and BV2 may be the control signals generated by the phase compensator controller 380 in FIG. 3. Alternatively, such bias voltages BV1 and BV2 may be provided externally when the present invention is practiced without the phase compensator controller 380.

The current source 340 sinks a sum of the first and second currents I11 and I12 to the ground node VSS. Otherwise, the operation of the phase compensator of FIG. 5 is substantially the same as the operation of the phase compensator of FIG. 4, as already described herein.

FIG. 9 is a graph illustrating IP2 values versus ΔR when Δη varies in Expression 5. In FIG. 9, curves A, B, C, D and E represent cases where Δη is +1%, 0%, −1%, −2% and −3%, respectively. FIG. 9 illustrates how the IP2 may be maximized by variation of Δη even with variation of ΔR.

In this manner, the phase compensator 320 minimizes intermodulation distortion and thus improves the IP2 characteristics of the DCR 300 by controlling the respective duty cycle of each of the compensated oscillating signals CLO+ and CLO−. The DCR 300 thus may have increased signal-to-noise ratio (SNR) and reception sensitivity.

While the example embodiments of the present invention and their advantages have been described in detail, it should be understood that various changes, substitutions and alterations may be made herein without departing from the scope of the invention.

the present invention is limited only as defined in the following claims and equivalents thereof.

What is claimed is:

1. An apparatus for frequency conversion, comprising:
a local oscillator that generates differential original oscillating signals;
a phase compensator that generates differential compensated oscillating signals from the original oscillating signals with a respective duty cycle of each of the compensated oscillating signals being adjusted by the phase compensator; and
a mixer that mixes the compensated oscillating signals with differential received signals to generate differential baseband signals.

2. The apparatus of claim 1, wherein the respective duty cycle of each of the compensated oscillating signals is adjusted for minimizing intermodulation distortion in the baseband signals.

3. The apparatus of claim 1, wherein the phase compensator includes:
a first differential amplifier, biased with a first current, and including first inputs with the original oscillating signals applied thereon, and including first outputs coupled to differential output terminals having the compensated oscillating signals generated thereon; and
a second differential amplifier, biased with a second current, and including second inputs with the original oscillating signals applied thereon, and including second outputs coupled to said differential pair of output terminals,
wherein the first and second currents are adjusted for setting the respective duty cycle of each of the compensated oscillating signals.

4. The apparatus of claim 3, wherein a sum of the first and second currents is maintained to be constant.

5. The apparatus of claim 3, wherein the phase compensator further includes:
a first BJT (bipolar junction transistor) for generating the first current and having a first base with a first base voltage applied thereon for setting the first current;
a second BJT (bipolar junction transistor) for generating the second current and having a second base with a second base voltage applied thereon for setting the second current; and
a current source coupled to the first and second BJTs and generating a fixed current such that a sum of the first and second currents is the fixed current.

6. The apparatus of claim 1, wherein the phase compensator includes:
a first differential amplifier, biased with a first current, and including a first pair of transistors with the original oscillating signals applied thereon, and including first outputs coupled to differential output terminals having the compensated oscillating signals generated thereon; and
a second differential amplifier, biased with a second current, and including a second pair of transistors with the original oscillating signals applied thereon, and including second outputs coupled to said differential output terminals,
wherein a first size ratio between the first pair of transistors and a second size ratio between the second pair of transistors are set for determining the respective duty cycle of each of the compensated oscillating signals.

7. The apparatus of claim 6, wherein a sum of the first and second currents is maintained to be constant.

8. A direct-conversion receiver (DCR) comprising:
a receiving unit for receiving differential RF signals;
a frequency conversion unit including:
a local oscillator that generates differential original oscillating signals;
a phase compensator that generates differential compensated oscillating signals from the original oscillating signals with a respective duty cycle of each of the compensated oscillating signals being adjusted by the phase compensator; and
a mixer that mixes the compensated oscillating signals with the received signals to generate differential baseband signals; and
a baseband signal processor for receiving and processing the baseband signals.

9. The DCR of claim 8, wherein the respective duty cycle of each of the compensated oscillating signals is adjusted for minimizing intermodulation distortion in the baseband signals.

10. The DCR of claim 9, further comprising:
a phase compensator controller that generates at least one control signal from the baseband signals, the phase compensator adjusting the respective duty cycle of each of the compensated oscillating signals in response to the at least one control signal.

11. The DCR of claim 8, wherein the phase compensator includes:
a first differential amplifier, biased with a first current, and including first inputs with the original oscillating signals applied thereon, and including first outputs coupled to differential output terminals having the compensated oscillating signals generated thereon; and
a second differential amplifier, biased with a second current, and including second inputs with the original oscillating signals applied thereon, and including second outputs coupled to said differential pair of output terminals,
wherein the first and second currents are adjusted for setting the respective duty cycle of each of the compensated oscillating signals.

12. The DCR of claim 11, wherein a sum of the first and second currents is maintained to be constant.

13. The DCR of claim 11, wherein the phase compensator further includes:
a first BJT (bipolar junction transistor) for generating the first current and having a first base with a first base voltage applied thereon for setting the first current;
a second BJT (bipolar junction transistor) for generating the second current and having a second base with a second base voltage applied thereon for setting the second current; and
a current source coupled to the first and second BJTs and generating a fixed current such that a sum of the first and second currents is the fixed current.

14. The DCR of claim 8, wherein the phase compensator includes:
a first differential amplifier, biased with a first current, and including a first pair of transistors with the original oscillating signals applied thereon, and including first outputs coupled to differential output terminals having the compensated oscillating signals generated thereon; and
a second differential amplifier, biased with a second current, and including a second pair of transistors with the original oscillating signals applied thereon, and including second outputs coupled to said differential output terminals,
wherein a first size ratio between the first pair of transistors and a second size ratio between the second pair of transistors are set for determining the respective duty cycle of each of the compensated oscillating signals.

15. The DCR of claim 14, wherein a sum of the first and second currents is maintained to be constant.

16. A method of frequency conversion, comprising:
generating differential original oscillating signals;
generating differential compensated oscillating signals from the original oscillating signals;
adjusting a respective duty cycle of each of the compensated oscillating signals; and
mixing the compensated oscillating signals with differential received signals to generate differential baseband signals.

17. The method of claim 16, further comprising:
adjusting the respective duty cycle of each of the compensated oscillating signals for minimizing intermodulation distortion in the baseband signals.

18. The method of claim 16, further including:
setting a first current through a first differential amplifier having first inputs with the original oscillating signals applied thereon and having first outputs coupled to differential output terminals having the compensated oscillating signals generated thereon; and
setting a second current through a second differential amplifier having second inputs with the original oscillating signals applied thereon and having second outputs coupled to said differential pair of output terminals,
wherein the first and second currents are adjusted for setting the respective duty cycle of each of the compensated oscillating signals.

19. The method of claim 18, further comprising:
maintaining a sum of the first and second currents to be constant.

20. The method of claim 16, further comprising:
setting a first size ratio between a first pair of transistors forming a first differential amplifier biased with a first current and having the original oscillating signals applied thereon, the first differential amplifier having first outputs coupled to differential output terminals having the compensated oscillating signals generated thereon; and
setting a second size ratio between a second pair of transistors forming a second differential amplifier biased with a second current and including a second pair of transistors with the original oscillating signals applied thereon, the second differential amplifier having second outputs coupled to said differential output terminals,
wherein the first size ratio and the second size ratio are set for determining the respective duty cycle of each of the compensated oscillating signals.

21. The method of claim 20, wherein a sum of the first and second currents is maintained to be constant.
